(19) United States
(12) Patent Application Publication
(10) Pub. No.: US 2021/0089595 A1
(43) Pub. Date: Mar. 25, 2021

(54) INFORMATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventors: Naoya TAKAYAMA, Kanagawa (JP); Miho ISHIZUKA, Kanagawa (JP)

(73) Assignee: FUJI XEROX CO., LTD., Tokyo (JP)

(21) Appl. No.: 16/812,708

(22) Filed: Mar. 9, 2020

(30) Foreign Application Priority Data
Sep. 20, 2019 (JP) 2019-172297

(51) Int. Cl. G06F 16/93; G06F 16/176; G06F 16/16; G06F 16/14

(52) U.S. Cl. CPC G06F 16/93; G06F 16/148; G06F 16/162; G06F 16/176

(57) ABSTRACT

An information processing apparatus includes a processor configured to sort electronic documents to a predetermined storage area based on attributes assigned to the electronic documents, receive an operation of changing the attributes, and control, based on the changed attributes, displaying of a storage area that stores the electronic documents when the electronic documents are re-sorted.

### CROSS-REFERENCE TO RELATED APPLICATIONS

This application is based on and claims priority under 35 USC 119 from Japanese Patent Application No. 2019-172297 filed Sep. 20, 2019.

### BACKGROUND

### (i) Technical Field

The present disclosure relates to an information processing apparatus and a non-transitory computer readable medium storing a program.

### (ii) Related Art

There is a system in which electronic documents are sorted based on character strings contained in the electronic documents as their attributes and the sorted electronic documents are stored in areas provided depending on their attributes. When any attribute is changed, the electronic documents are re-sorted based on the changed attribute.

Japanese Unexamined Patent Application Publication No. 11-144027 describes a file management system in which a CPU receives an instruction for a common attribute (template) when documents are registered and collectively registers attributes of one or more documents by using the template when the documents are registered.

Japanese Unexamined Patent Application Publication No. 11-288417 describes a document management system. In the document management system, digitized documents are sorted based on document attributes and are stored in folders provided depending on the attributes used for the sorting. The document management system includes an inputter that divides attribute data into a plurality of pieces of sub-attribute data, provides a hierarchical structure for the pieces of sub-attribute data, and inputs the pieces of sub-attribute data, an editor that links the plurality of pieces of sub-attribute data in the hierarchical structure and associates the pieces of sub-attribute data with sorting folders, an attribute data holding area that stores the plurality of pieces of input sub-attribute data in the hierarchical state, and a holding area that stores attribute data edited by the editor.

### SUMMARY

Aspects of non-limiting embodiments of the present disclosure relate to the following circumstances. When electronic documents are re-sorted, a user does not easily grasp a storage area that stores the electronic documents.

It is desirable to provide an information processing apparatus and the like in which, when attributes of electronic documents are changed and the electronic documents are re-sorted, a user may grasp more easily a storage area that stores the re-sorted electronic documents than in a case where the storage area of the electronic documents is not displayed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus comprising a processor configured to sort electronic documents to a predetermined storage area based on attributes assigned to the electronic documents, receive an operation of changing the attributes, and control, based on the changed attributes, displaying of a storage area that stores the electronic documents when the electronic documents are re-sorted.

### BRIEF DESCRIPTION OF THE DRAWINGS

An exemplary embodiment of the present disclosure will be described in detail based on the following figures, wherein:

FIG. 1 illustrates a setting screen to be used for setting attributes to electronic documents in an information processing apparatus;

FIGS. 2A and 2B illustrate a rule using attributes and storage areas of electronic documents;

FIG. 3 is a block diagram illustrating an example of the functional configuration of the information processing apparatus;

FIG. 4 is a flowchart illustrating a process to be performed by a sorter to re-sort electronic documents;

FIG. 5 illustrates a search screen to be used by a user to search for electronic documents whose attributes will be changed;

FIG. 6 illustrates search results;

FIG. 7 illustrates a collective change screen;

FIG. 8 is a flowchart illustrating a method for determining a display method for folder structures by the sorter;

FIG. 9A illustrates a screen to be displayed on a display in Step 204 of FIG. 8;

FIG. 9B illustrates a screen to be displayed on the display in Step 208 of FIG. 8;

FIG. 10A illustrates a collective change screen in a case where the sorter creates a new re-sorting folder in Step 202 of FIG. 8;

FIG. 10B illustrates a collective change screen in a case where a re-sorting folder exists in Step 203 of FIG. 8;

FIG. 11A illustrates a collective change screen in a case where the sorter keeps an original folder when any file remains in the original folder in Step 207 of FIG. 8; and

FIG. 11B illustrates a collective change screen in a case where the sorter deletes the original folder when no file remains in the original folder in Step 207 of FIG. 8.

### DETAILED DESCRIPTION

### <Operation of Information Processing Apparatus 10>

An information processing apparatus 10 of this exemplary embodiment manages, for example, electronic documents.

The “electronic document” is digitized information. The type of information, format, and data structure are not particularly limited as long as the electronic document may be handled by the information processing apparatus 10. Examples of the “electronic document” include character information, image information, software such as a program, and software-related information such as setting information. In this exemplary embodiment, the electronic document is print information to be used for printing a paper document called “estimation sheet”, “order sheet”, or “invoice”. For example, the electronic document is image information obtained by scanning the paper document.

Examples of the information processing apparatus 10 include a general-purpose personal computer (PC), a mobile computer, a mobile phone, a smartphone, and a tablet. The information processing apparatus 10 manages electronic documents by operating various types of application software under control of an operating system (OS).

For example, the information processing apparatus 10 may be a server computer that manages the entire system in which electronic documents are handled. In this case, the information processing apparatus 10, for example, authenticates a user who operates a terminal apparatus connected to the information processing apparatus 10 and transmits an electronic document to the terminal apparatus so that the user may view the electronic document. Further, the information processing apparatus 10 receives and stores an electronic document created at the terminal apparatus. If the information processing apparatus 10 is provided in a cloud system, the information processing apparatus 10 may be a cloud server that provides management services for electronic documents.

The information processing apparatus 10 includes a central processing unit (CPU) serving as a calculator, a memory such as a main memory, and a storage such as a hard disk drive (HDD) or a solid state drive (SSD). The CPU is an example of a processor, which executes various types of software such as an OS (basic software) or application software. The main memory is a storage area that stores various types of software and data to be used for executing the software. The storage is a storage area that stores data input to various types of software and data to be output from the software.

The information processing apparatus 10 includes a communication interface (I/F) for external communication, a display mechanism including a video memory and a display, and an input device such as a keyboard, a mouse, or a touch panel.

The information processing apparatus 10 assigns attributes to electronic documents and manages the electronic documents based on the attributes.

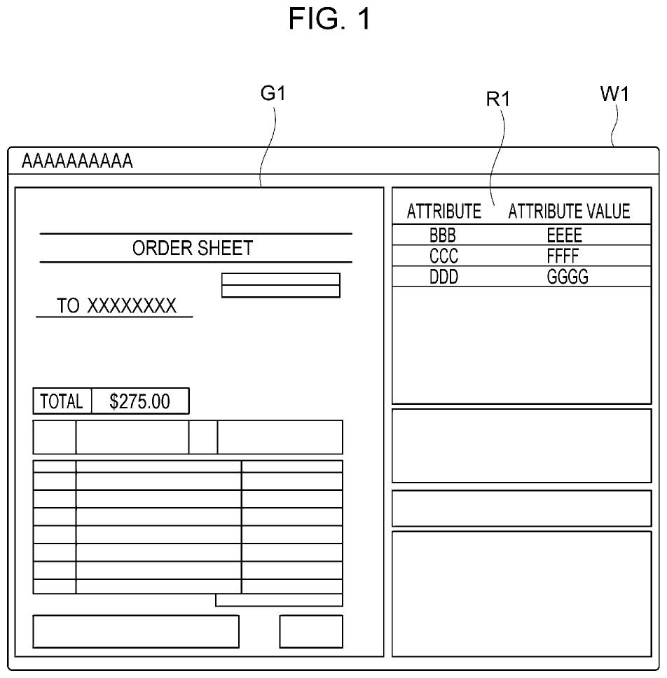

FIG. 1 illustrates a setting screen to be used for setting attributes to electronic documents in the information processing apparatus 10.

The setting screen is displayed as a window W1. A thumbnail screen G1 of an electronic document whose attributes will be set is displayed at the left of the window W1. A thumbnail screen G1 of an order sheet is displayed as the electronic document. An input field R1 to be used for inputting attributes is displayed at an upper right part of the window W1. A user inputs attributes in the input field R1 by using the input device.

The information processing apparatus 10 may determine storage areas of electronic documents by setting rules using the attributes. The storage area is a storage destination of an electronic document, as typified by a folder. By setting the rules, electronic documents may be sorted and stored in desired folders.

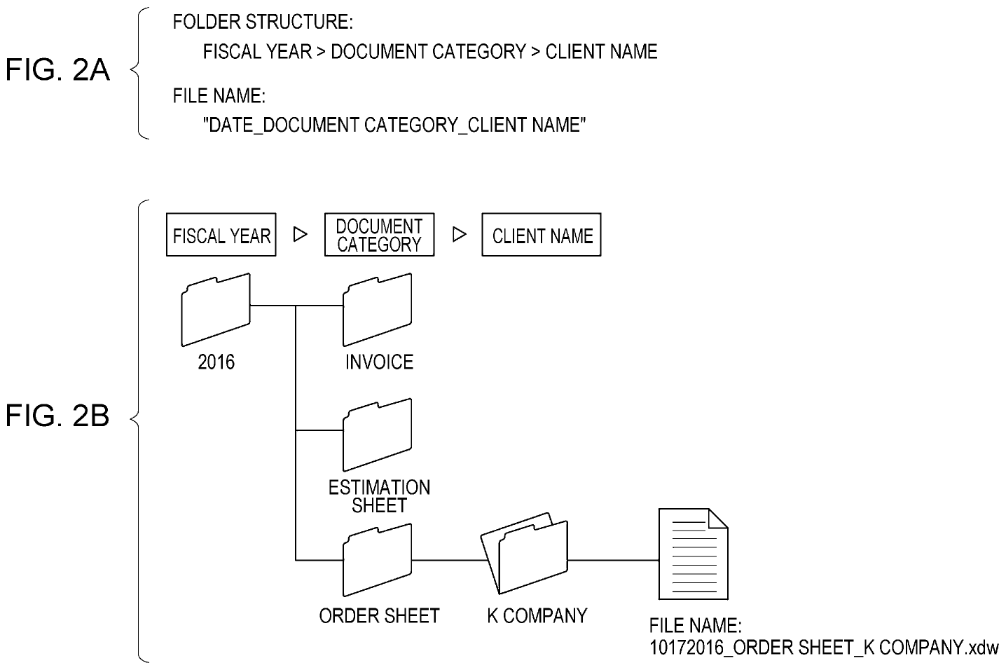

FIGS. 2A and 2B illustrate the rule using the attributes and the storage areas of electronic documents.

FIG. 2A illustrates the rule using the attributes. The rule is represented by a relationship between a folder structure and a file name. The folder structure indicates folders serving as storage areas of an electronic document. The electronic document has a file name necessary for storage of the electronic document in the folders. The rule shows that the file name shall be “date_document category_client name” to store an electronic document in folders represented by a structure “fiscal year>document category>client name”. The fiscal year, the document category, and the client name are examples of the attribute.

The rule may be preset by a user who operates and manages the information processing apparatus 10.

FIG. 2B illustrates how an electronic document is actually stored in folders. In this case, the file name of the electronic document is “10172016_order sheet_K company.xdw”. That is, the file name indicates that the date is “Oct. 17, 2016”, the document category is “order sheet”, and the client name is “K company”. The folders that store the electronic document is represented by “2016>order sheet>K company”. That is, the electronic document is stored in folders with a fiscal year “2016”, a document category “order sheet”, and a client name “K company”.

### <Functional Configuration of Information Processing Apparatus 10>

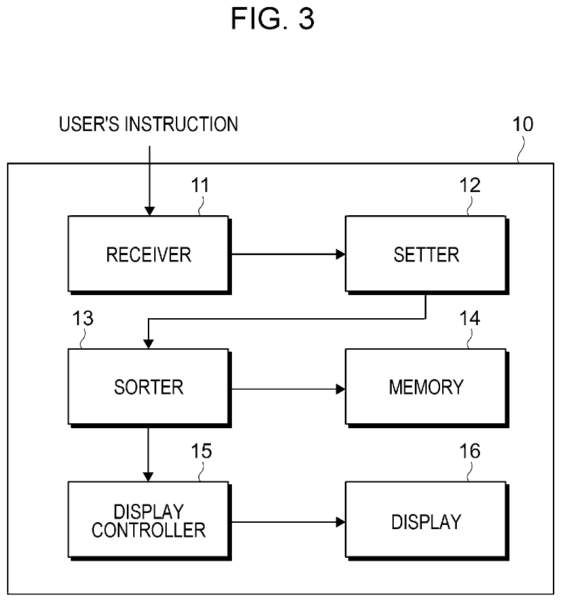

FIG. 3 is a block diagram illustrating an example of the functional configuration of the information processing apparatus 10.

FIG. 3 selectively illustrates functions related to this exemplary embodiment among various functions of the information processing apparatus 10.

The information processing apparatus 10 includes a receiver 11 that receives user-s instructions, a setter 12 that sets attributes of electronic documents, a sorter 13 that sorts electronic documents, a memory 14 that stores electronic documents, a display controller 15 that controls a display screen on a display 16, and the display 16 that displays electronic documents.

In this exemplary embodiment, the receiver 11 receives an operation of setting attributes on the screen illustrated in FIG. 1. When any attribute needs to be changed, the receiver 11 receives an operation of changing the attribute. For example, the receiver 11 corresponds to the CPU and the input device.

The setter 12 sets attributes. That is, when the receiver 11 receives an operation of setting attributes, the setter 12 assigns the set attributes to an electronic document. When any attribute is changed, the setter 12 collectively changes the attributes of target electronic documents. For example, the setter 12 corresponds to the CPU.

When an operation of setting attributes is received on the screen illustrated in FIG. 1, the sorter 13 allocates an electronic document to a predetermined storage area based on the set attributes. When any attribute is changed, the sorter 13 sorts electronic documents to a predetermined storage area based on the changed attributes. That is, the sorter 13 re-sorts electronic documents. For example, the sorter 13 corresponds to the CPU.

The memory 14 stores electronic documents. The memory 14 also stores set attributes. The memory 14 may store dates of creation, dates of modification, or records of modification for electronic documents. For example, the memory 14 corresponds to the main memory and the storage.

Although details are described later, the display controller 15 controls, based on a changed attribute, displaying of storage areas that store electronic documents when they are re-sorted. For example, the display controller 15 corresponds to the CPU.

The display 16 displays images of electronic documents and the setting screen illustrated in FIG. 1. The display 16 is not particularly limited as long as the display 16 has a function of displaying images. Examples of the display 16 include a liquid crystal display panel, a cathode-ray tube, a plasma display panel, and a projector. For example, the display 16 corresponds to the display mechanism.

### <Operation of Re-Sorting Electronic Documents>

When any attribute is changed, the sorter 13 re-sorts electronic documents as described above. This operation is described below in detail.

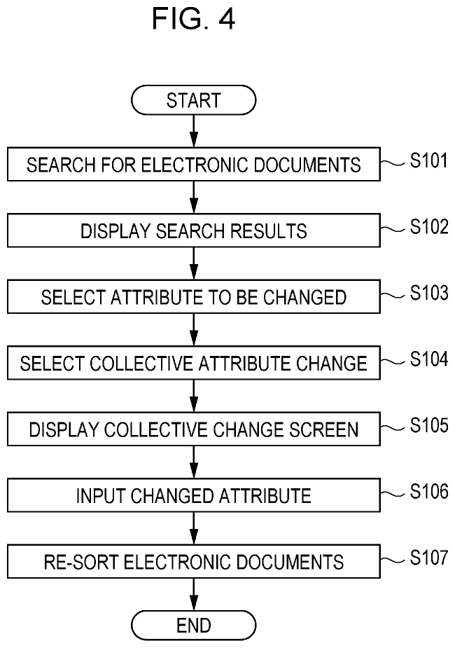

FIG. 4 is a flowchart illustrating a process to be performed by the sorter 13 to re-sort electronic documents.

First, a user searches for electronic documents whose attributes will be changed (Step 101).

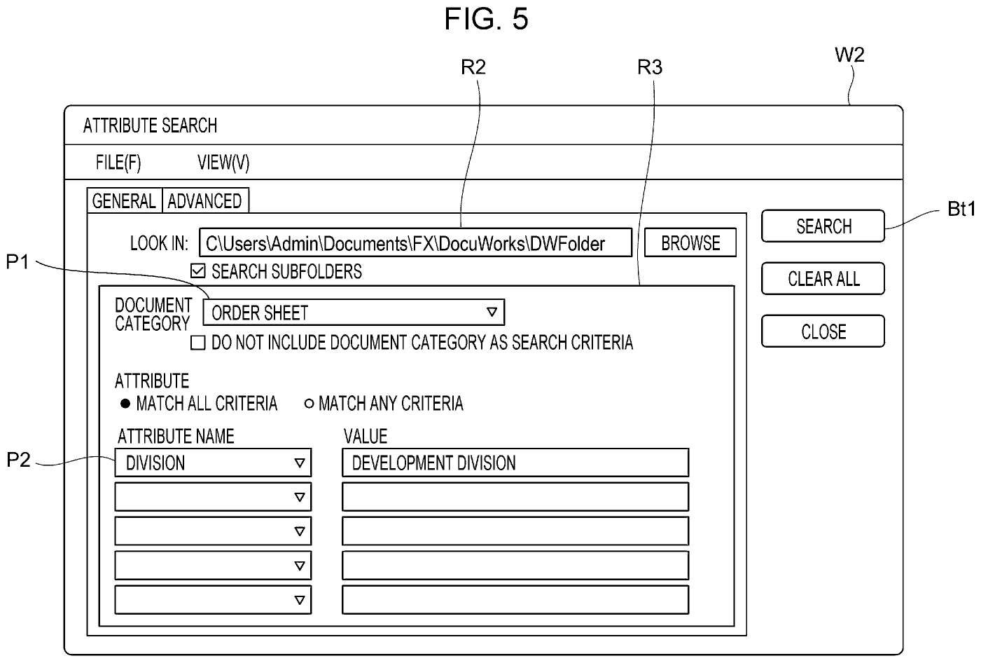

FIG. 5 illustrates a search screen to be used by the user to search for electronic documents whose attributes will be changed.

The search screen is displayed as a window W2 on the display 16. An input field R2 is displayed as a search field at an upper part of the window W2 in FIG. 5. The user may specify a drive or folder to be searched in the input field R2.

An input field R3 to be used for inputting attributes is displayed at a lower part of the window W2 in FIG. 5. The user may search for electronic documents whose attributes matches attributes input in the input field R3. With a pull-down menu P1 in the input field R3, the user is going to search for electronic documents whose “document categories” are “order sheets”. Attributes for searching may be specified below the pull-down menu P1 in FIG. 5. With a pull-down menu P2, the user is going to select an attribute “division” to search for electronic documents in which the divisions are “development divisions”.

The user pushes a search button Bt1 to search for electronic documents based on the search criteria input by the user.

Referring back to FIG. 4, the display 16 displays results of the search in Step 101 (Step 102).

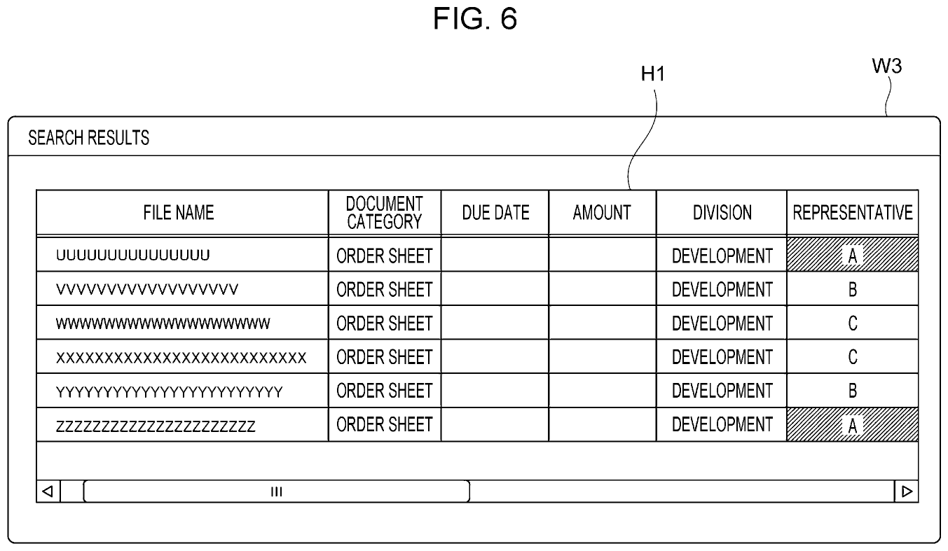

FIG. 6 illustrates the search results.

The search results show electronic documents in which the document categories are “order sheets” and the divisions are “development divisions”. The search results are displayed as a window W3 on the display 16. A list H1 is displayed in the window W3 as the search results. The list H1 includes a file name, a document category, a due date, an amount, a division, and a representative. File names of electronic documents in which the document categories are “order sheets” and the divisions are “development divisions” are displayed. The due date, amount, division, and representative are attributes. If the electronic documents are assigned those attributes, the attributes are displayed in the list H1. If the electronic documents are not assigned the attributes, the fields are left blank. In this case, the attributes “due date” and “amount” are not assigned to each electronic document. The attribute “representative” is assigned and representatives A to C are displayed.

Referring back to FIG. 4, the user selects an attribute to be changed from the search results (Step 103).

The following description is directed to a case where a representative is changed as the attribute. The user selects a representative to be changed from the representative fields and inputs a changed representative as a substitute. In FIG. 6, the representative A is selected as the representative to be changed and the fields of the representative A are highlighted.

The user selects an item “collective attribute change” from a menu (not illustrated) (Step 104) and a collective change screen is displayed (Step 105).

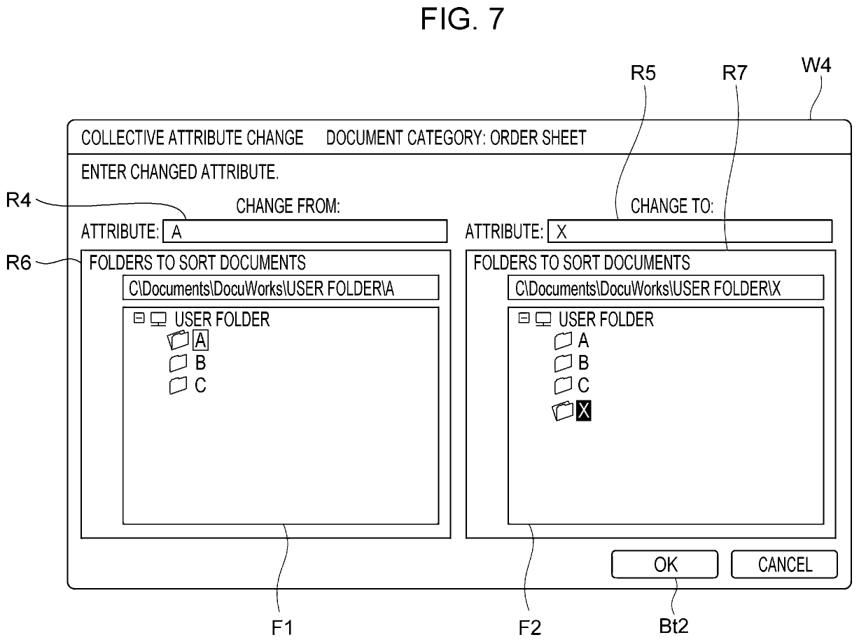

FIG. 7 illustrates the collective change screen.

The collective change screen is displayed as a window W4 on the display 16. A field R4 showing an attribute to be changed is displayed at an upper left part of the window W4 in FIG. 7. An input field R5 to be used for inputting a changed attribute is displayed at an upper right part of the window W4 in FIG. 7. In this case, the representative A is displayed as the attribute to be changed and a representative X is input in the input field R5 as the changed attribute.

A folder structure F1 associated with the attribute to be changed is displayed at a lower left part of the window W4 in FIG. 7. Folders A to C exist in a user folder as folders for the representatives A to C. That is, electronic documents related to the representatives A to C are sorted and stored in the folders A to C, respectively.

A folder structure F2 associated with the changed attribute is displayed at a lower right part of the window W4 in FIG. 7. The folder structure F2 is displayed when any attribute is input in the input field R5. In this case, a folder X is displayed in the user folder as a folder for the representative X in addition to the folders A to C. The folder X is highlighted to indicate its addition.

In this case, the electronic documents related to the representative A that are displayed as the search results in the window W3 of FIG. 6 will be moved to the folder X. That is, the electronic documents will be re-sorted as a result of the attribute change. A field R6 and a field R7 showing re-sorting folders demonstrate that the electronic documents related to the representative A will be re-sorted from the folder A to the folder X. In the folder structure F1, the folder A is colored or boxed. In the folder structure F2, the folder X is highlighted as the added folder.

In this case, the sorter 13 determines the re-sorting folder based on the rule described above. Therefore, the rule needs to be preset. In actuality, when any attribute is changed, the sorter 13 searches for a rule associated with the attribute change. If the rule exists, the electronic documents are re-sorted.

If no rule exists, the electronic documents are not re-sorted and only the attribute value is changed. In this case, the folder structures F1 and F2 at the lower part of the window W4 are not displayed, or are displayed in the same way with no emphasis of folders with color or the like.

When the user inputs the changed attribute (Step 106), the re-sorting folders of the electronic documents are displayed one by one. When the user pushes an OK button Bt2, the attributes of the target electronic documents are collectively changed and the electronic documents are re-sorted (Step 107).

The display method for the folder structures F1 and F2 at the lower part of the window W4 in FIG. 7 is not limited to the method in FIG. 7.

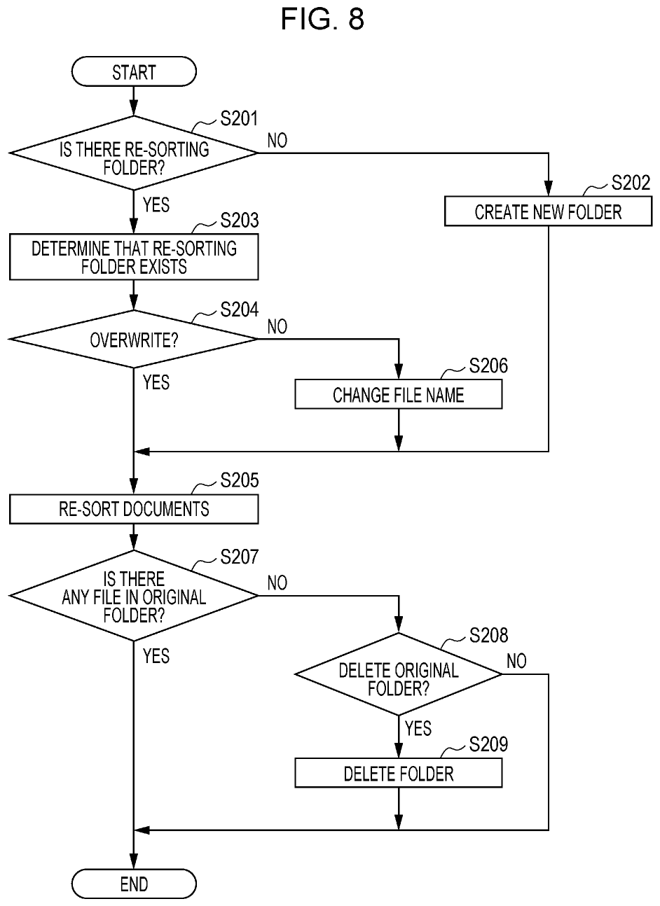

FIG. 8 is a flowchart illustrating a method for determining the display method for the folder structures F1 and F2 by the sorter 13.

First, the sorter 13 determines whether a re-sorting folder associated with a changed attribute already exists (Step 201). In the example of FIG. 7, the sorter 13 determines whether the folder X already exists.

If the re-sorting folder does not exist (“NO” in Step 201), the sorter 13 creates a new re-sorting folder (Step 202). Then, the process proceeds to Step 205 and electronic documents are moved to the re-sorting folder.

If the re-sorting folder exists (“YES” in Step 201), the sorter 13 determines that the re-sorting folder exists (Step 203).

If any electronic document in the re-sorting folder has the same file name, the sorter 13 prompts the user to decide whether to overwrite the electronic document (Step 204).

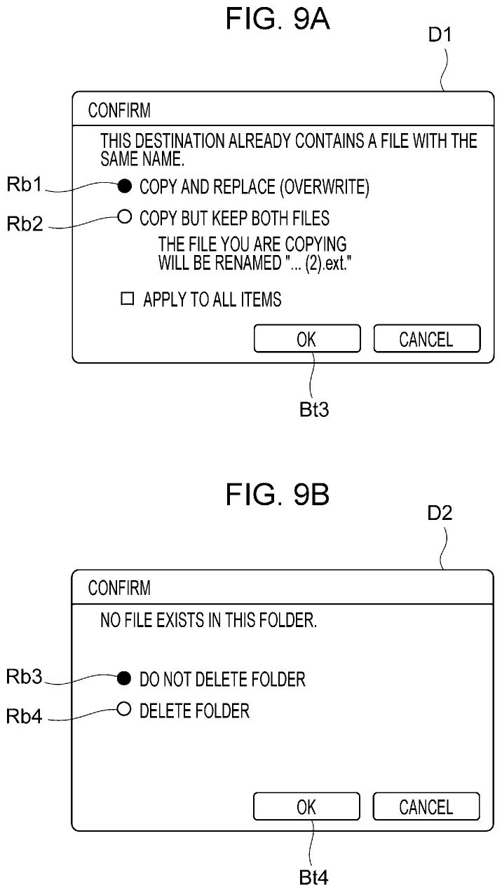

FIG. 9A illustrates a screen to be displayed on the display 16 in Step 204.

The screen is displayed as a dialog D1. A radio button Rb1 and a radio button Rb2 are displayed and the user may choose to overwrite the file or move the file by changing its name. When the user selects the radio button Rb1 or the radio button Rb2 and pushes an OK button Bt3, the selected process is executed.

Referring back to FIG. 8, if the user selects the radio button Rb1 to overwrite the file in FIG. 9A (“YES” in Step 204), the electronic document overwrites the existing electronic document and moves to the re-sorting folder (Step 205).

If the user selects the radio button Rb2 to change the file name in FIG. 9A (“NO” in Step 204), the file name of the electronic document is changed (Step 206) and the electronic document moves to the re-sorting folder (Step 205).

Next, the sorter 13 determines whether any file remains in the original folder as a result of moving the electronic documents (Step 207).

If any file remains (“YES” in Step 207), the sorter 13 terminates the series of processes. That is, the sorter 13 keeps the original folder.

If no file remains (“NO” in Step 207), the sorter 13 prompts the user to decide whether to delete the original folder (Step 208).

FIG. 9B illustrates a screen to be displayed on the display 16 in Step 208.

The screen is displayed as a dialog D2. A radio button Rb3 and a radio button Rb4 are displayed and the user may choose whether to delete the folder or not. When the user selects the radio button Rb3 or the radio button Rb4 and pushes an OK button Bt4, the selected process is executed.

Referring back to FIG. 8, if the user selects the radio button Rb3 so as not to delete the folder in FIG. 9B (“NO” in Step 208), the sorter 13 terminates the series of processes. That is, the sorter 13 keeps the original folder.

If the user selects the radio button Rb4 to delete the folder (“YES” in Step 208), the sorter 13 deletes the original folder (Step 209).

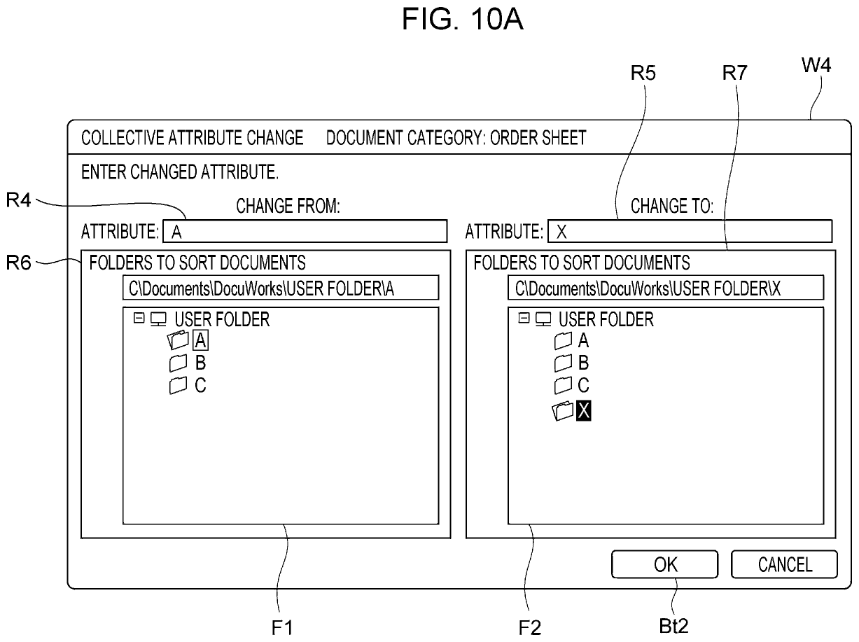

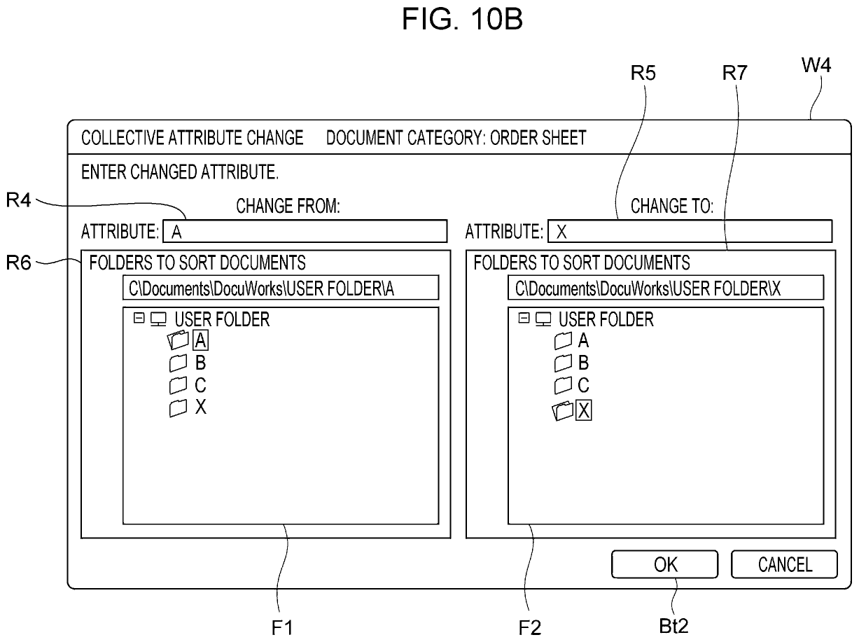

FIG. 10A illustrates a collective change screen in a case where the sorter 13 creates a new re-sorting folder in Step 202 of FIG. 8.

In this case, the collective change screen is displayed as a window W4 similar to that of FIG. 7. That is, the folder X does not exist in the original folder structure F1 and is therefore newly created in the folder structure F2 after re-sorting.

FIG. 10B illustrates a collective change screen in a case where the re-sorting folder exists in Step 203 of FIG. 8.

In this case, the folder X exists in the original folder structure F1. Therefore, the same folders are displayed in the folder structure F1 and in the folder structure F2 after re-sorting. That is, the folders A to C and X are displayed in both the folder structures.

The folder A in the folder structure F1 and the folder X in the folder structure F2 are colored or boxed.

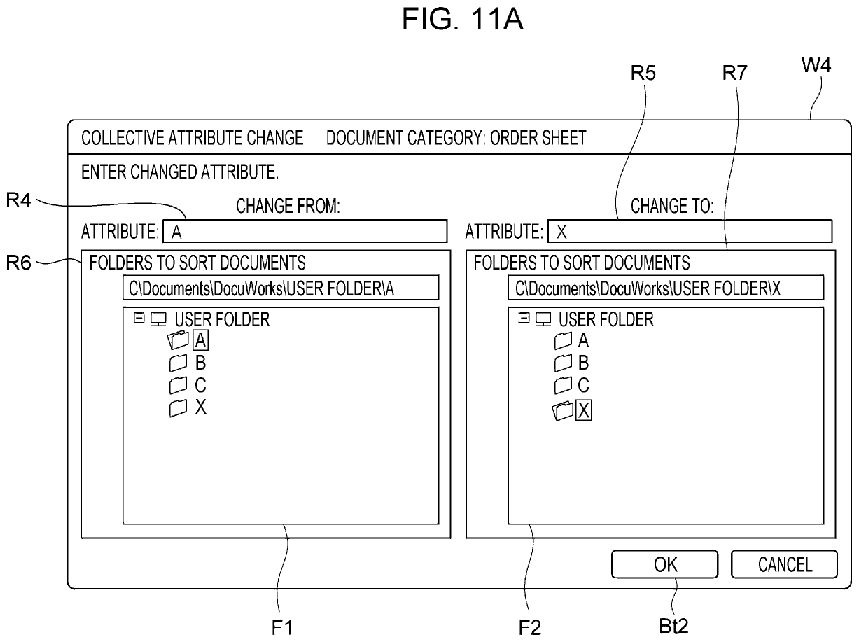

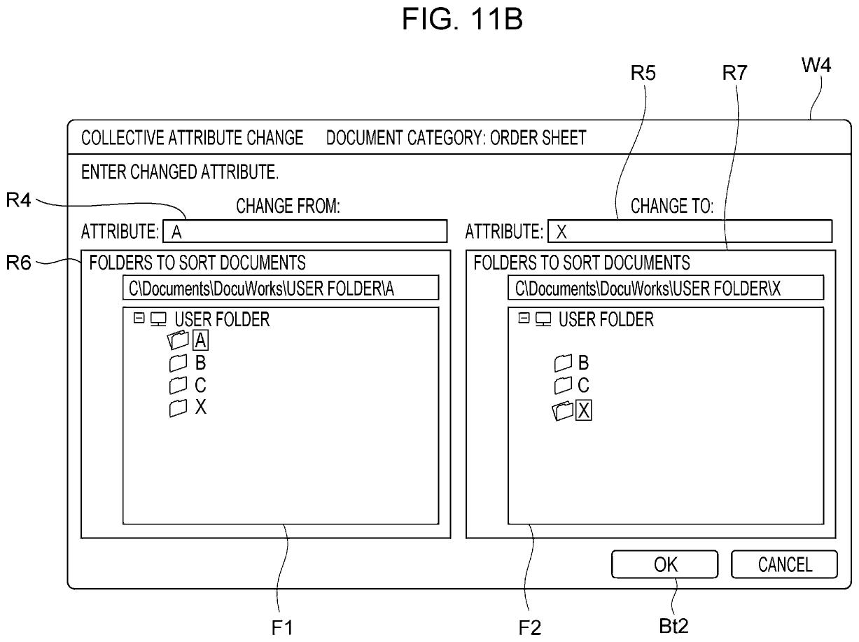

FIG. 11A illustrates a collective change screen in a case where the sorter 13 keeps the original folder when any file remains in the original folder in Step 207 of FIG. 8.

In this case, the folder X exists in the original folder structure F1. Therefore, the same folders are displayed in the folder structure F1 and in the folder structure F2 after re-sorting. Since a file remains in the original folder A, the folder A is not deleted but kept.

The folder A in the folder structure F1 and the folder X in the folder structure F2 are colored or boxed.

FIG. 11B illustrates a collective change screen in a case where the sorter 13 deletes the original folder when no file remains in the original folder in Step 207 of FIG. 8.

In this case, the folder A is deleted in the folder structure F2 after re-sorting. As a result, the folder A is not displayed.

The folder A in the folder structure F1 and the folder X in the folder structure F2 are colored or boxed.

As demonstrated with reference to the collective change screen of FIG. 7, the sorter 13 of this exemplary embodiment searches for electronic documents based on attributes assigned to the electronic documents, and receives an operation of changing the attributes of the retrieved electronic documents. The sorter 13 controls, based on the changed attributes, displaying of a storage area that stores the electronic documents when they are re-sorted. The sorter 13 controls displaying of a storage area that stores the electronic documents before they are re-sorted, in association with the storage area that stores the electronic documents when they are re-sorted. That is, the fields R6 and R7 and the folder structures F1 and F2 are displayed.

As demonstrated with reference to the collective change screens of FIG. 7 and FIG. 10A, if no storage area exists in association with the changed attributes, the sorter 13 of this exemplary embodiment creates a new storage area. The display 16 displays the created new storage area as a storage area that stores the electronic documents when they are re-sorted. That is, in FIG. 7 and FIG. 10A, the folder X is newly created as a storage area for the representative X. The display 16 displays the newly created folder X.

The sorter 13 determines the storage area that stores the electronic documents when they are re-sorted based on a preset rule showing the relationship between the attributes and the storage area.

If no rule exists in association with the attribute change, the sorter 13 avoids displaying the storage area that stores the electronic documents when they are re-sorted, and avoids re-sorting the electronic documents.

As demonstrated with reference to the collective change screen of FIG. 11B, if any storage area contains no electronic document after the electronic documents are re-sorted, the sorter 13 of this exemplary embodiment deletes the storage area containing no electronic document and displays an indication that the storage area containing no electronic document is deleted. That is, in FIG. 11B, the folder A for the representative A is displayed in the original folder structure F1. After re-sorting, the folder A is deleted and is not displayed in the folder structure F2.

As illustrated in FIG. 9B, the sorter 13 deletes the storage area containing no electronic document after permission of the user. That is, the folder A is not deleted unconditionally, but is deleted after permission of the user.

### <Program>

The processes to be performed by the information processing apparatus 10 of this exemplary embodiment are prepared as a program such as application software. The processes are implemented in cooperation between software and hardware resources.

In this exemplary embodiment, the program for executing the processes to be performed by the information processing apparatus 10 may cause a computer to implement a sorting function for sorting electronic documents to a predetermined storage area based on attributes assigned to the electronic documents, a receiving function for receiving an operation of changing the attributes, and a display control function for controlling, based on the changed attributes, displaying of a storage area that stores the electronic documents when they are re-sorted.

The program that implements this exemplary embodiment may be provided not only by any communication method but also by being stored in any recording medium such as a CD-ROM.

In the embodiment above, the term “processor” refers to hardware in a broad sense. Examples of the processor includes general processors (e.g., CPU: Central Processing Unit), dedicated processors (e.g., GPU: Graphics Processing Unit, ASIC: Application Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising a processor configured to
sort electronic documents to a predetermined storage area based on attributes assigned to the electronic documents,
receive an operation of changing the attributes, and
control, based on the changed attributes, displaying of a storage area that stores the electronic documents when the electronic documents are re-sorted.

2. The information processing apparatus according to claim 1, wherein the processor is configured to
search for electronic documents based on attributes assigned to the electronic documents,
receive an operation of changing the attributes of the retrieved electronic documents, and
control, based on the changed attributes, displaying of a storage area that stores the retrieved electronic documents when the retrieved electronic documents are re-sorted.

3. The information processing apparatus according to claim 2, wherein the processor determines the storage area that stores the retrieved electronic documents when the retrieved electronic documents are re-sorted based on a preset rule showing a relationship between the attributes and the storage area.

4. The information processing apparatus according to claim 3, wherein, if the rule does not exist in association with the changing of the attributes, the processor avoids displaying the storage area that stores the retrieved electronic documents when the retrieved electronic documents are re-sorted, and avoids re-sorting the retrieved electronic documents.

5. The information processing apparatus according to claim 1, wherein the processor controls displaying of the storage area that stores the electronic documents before the electronic documents are re-sorted, in association with the storage area that stores the electronic documents when the electronic documents are re-sorted.

6. The information processing apparatus according to claim 5, wherein the processor is configured to
create a new storage area if no storage area exists in association with the changed attributes, and
display the created new storage area as the storage area that stores the electronic documents when the electronic documents are re-sorted.

7. The information processing apparatus according to claim 5, wherein the processor is configured to
if any storage area contains no electronic document after the electronic documents are re-sorted, delete the storage area containing no electronic document, and
display an indication that the storage area containing no electronic document is deleted.

8. The information processing apparatus according to claim 7, wherein the processor deletes the storage area containing no electronic document after permission of a user.

9. A non-transitory computer readable medium storing a program causing a computer to execute a process comprising:
sorting electronic documents to a predetermined storage area based on attributes assigned to the electronic documents,
receiving an operation of changing the attributes, and
controlling, based on the changed attributes, displaying of a storage area that stores the electronic documents when the electronic documents are re-sorted.

10. An information processing apparatus comprising:
means for sorting electronic documents to a predetermined storage area based on attributes assigned to the electronic documents;
means for receiving an operation of changing the attributes; and
means for controlling, based on the changed attributes, displaying of a storage area that stores the electronic documents when the electronic documents are re-sorted.
